(19) United States
(12) Patent Application Publication
(10) Pub. No.: US 2006/0060623 A1
(43) Pub. Date: Mar. 23, 2006

(54) Bike carrying rack for automobile

(76) Inventor: Chin-Sung Huang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/944,067

(22) Filed: Sep. 20, 2004

(51) Int. Cl. B60R 9/00

(52) U.S. Cl. 224/504; 224/924

(57) ABSTRACT

A bike carrying rack for an automobile bike carrying rack includes a U-shaped first mounting bracket, a U-shaped second mounting bracket, a U-shaped support bracket, and two positioning links. Thus, the first mounting bracket is pivoted relative to the second mounting bracket to adjust the included angle between the first mounting bracket and the second mounting bracket, so that the included angle of the bike carrying rack is adjusted freely to fit cars of different types, thereby enhancing the versatility of the bike carrying rack.

### BACKGROUND OF THE INVENTION

1. Field of the Invention

The present invention relates to a bike carrying rack, and more particularly to a bike carrying rack for use with an automobile, a car having an oblique rear side, a caravan or the like.

2. Description of the Related Art

A conventional bike carrying rack for an automobile comprises a first body, and a second body pivotally mounted on the first body. When the bike carrying rack is mounted on an automobile, the bicycle is supported by the first body of the bike carrying rack. However, the support strength of the first body of the bike carrying rack is limited, so that the bike carrying rack is only available for a common car, thereby limiting the versatility of the bike carrying rack. In addition, the conventional bike carrying rack has a larger volume when being folded, thereby causing inconvenience to a user in storage and transportation of the bike carrying rack. Further, the first body and the second body of the bike carrying rack are directly rested on the body of the car, so that the body of the car is easily scratched.

### SUMMARY OF THE INVENTION

In accordance with the present invention, there is provided a bike carrying rack, comprising:

a substantially U-shaped first mounting bracket having two sides each formed with a first pivot base, a pivot hole and at least one first positioning hole;

a substantially U-shaped second mounting bracket pivotally mounted on the first mounting bracket and having two sides each formed with a second pivot base pivotally mounted on the first pivot base, a second positioning hole and at least one third positioning hole;

a substantially U-shaped support bracket pivotally mounted on the first mounting bracket and having two sides each having a first end formed with a pivot hole pivotally mounted on the respective pivot hole of the first mounting bracket and a mediate portion formed with a locking hole; and

two positioning links each mounted between the first mounting bracket, the second mounting bracket and the support bracket and each having a first end formed with a locking hole mounted on the respective locking hole of the support bracket and a second end formed with at least one positioning hole selectively mounted on either one of the respective first positioning hole of the first mounting bracket, the second positioning hole and the third positioning hole of the second mounting bracket.

The primary objective of the present invention is to provide a bike carrying rack, wherein the first mounting bracket is pivoted relative to the second mounting bracket to adjust the included angle between the first mounting bracket and the second mounting bracket, so that the included angle of the bike carrying rack is adjusted freely to fit cars of different types, thereby enhancing the versatility of the bike carrying rack.

Another objective of the present invention is to provide a bike carrying rack, wherein the first pivot base of the first mounting bracket and the second pivot base of the second mounting bracket are combined with and detached from each other by operation of the quick release, so that the included angle between the first mounting bracket and the second mounting bracket is adjusted easily and conveniently, thereby facilitating a user adjusting the included angle of the bike carrying rack.

A further objective of the present invention is to provide a bike carrying rack, wherein the support bracket is fixed between the first mounting bracket and the second mounting bracket by support of the two positioning links so as to enhance the support strength of the bike carrying rack.

A further objective of the present invention is to provide a bike carrying rack, wherein the bike carrying rack is folded to reduce its volume when not in use, thereby facilitating storage and transportation of the bike carrying rack.

A further objective of the present invention is to provide a bike carrying rack, wherein the flattened faces of the rubber pads are rested on the body of the car to support the bike carrying rack rigidly and stably and to prevent the body of the car from being scratched.

A further objective of the present invention is to provide a bike carrying rack, wherein the bike carrying rack is mounted on a vertical wall for supporting a bicycle, thereby enhancing the versatility of the bike carrying rack.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bike carrying rack in accordance with the preferred embodiment of the present invention;

FIG. 2 is an exploded perspective view of the bike carrying rack as shown in FIG. 1;

FIG. 2A is a partially perspective view of a first mounting bracket of the bike carrying rack as shown in FIG. 2;

FIG. 3 is a partially plan cross-sectional view of the bike carrying rack as shown in FIG. 1;

FIG. 4 is a schematic plan operational view of the bike carrying rack as shown in FIG. 1 for use with a car;

FIG. 5 is a perspective view of the bike carrying rack as shown in FIG. 4 for supporting a bicycle;

FIG. 6 is a schematic plan operational view of the bike carrying rack as shown in FIG. 1 for use with a car;

FIG. 7 is a schematic plan operational view of the bike carrying rack as shown in FIG. 1 for use with a caravan;

FIG. 8 is a schematic plan operational view of the bike carrying rack as shown in FIG. 1 for mounting to a vertical wall;

FIG. 9 is a schematic plan folded view of the bike carrying rack as shown in FIG. 1.

### DETAILED DESCRIPTION OF THE INVENTION

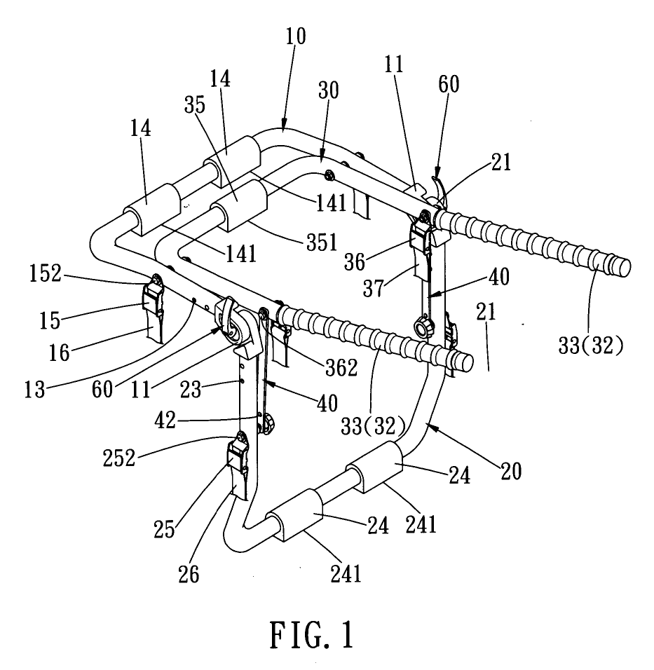

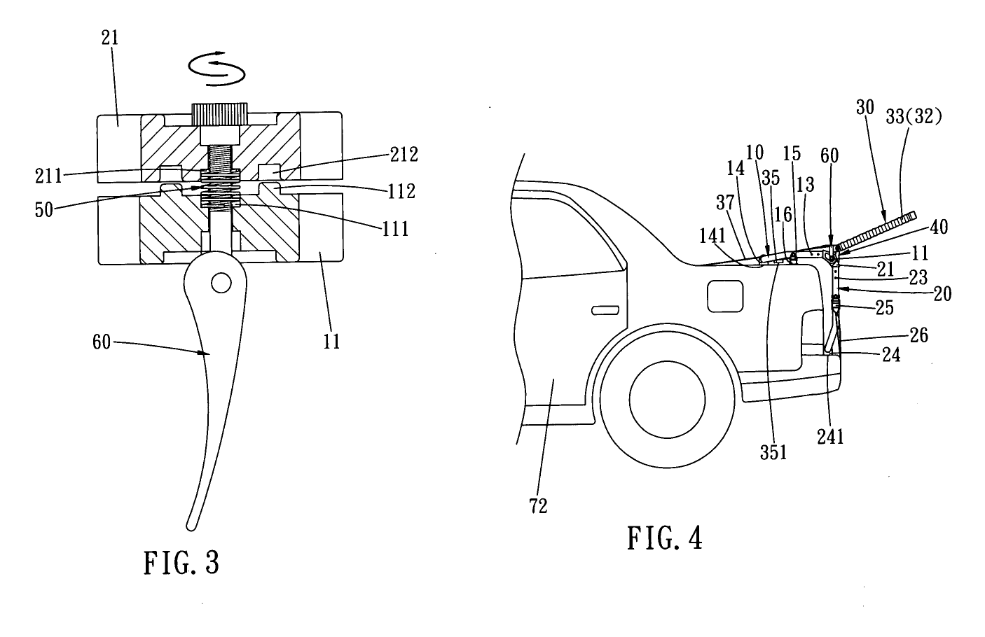

Referring to the drawings and initially to FIGS. 1-3, a bike carrying rack for an automobile in accordance with the preferred embodiment of the present invention comprises a substantially U-shaped first mounting bracket 10 having two sides each formed with a first pivot base 11, a pivot hole 12 and at least one first positioning hole 13, a substantially U-shaped second mounting bracket 20 pivotally mounted on the first mounting bracket 10 and having two sides each formed with a second pivot base 21 pivotally mounted on the first pivot base 11, a second positioning hole 22 and at least one third positioning hole 23, a substantially U-shaped support bracket 30 pivotally mounted on the first mounting bracket 10 and having two sides each having a first end formed with a pivot hole 34 pivotally mounted on the respective pivot hole 12 of the first mounting bracket 10 and a mediate portion formed with a locking hole 31, and two positioning links 40 each mounted between the first mounting bracket 10, the second mounting bracket 20 and the support bracket 30 and each having a first end formed with a locking hole 41 mounted on the respective locking hole 31 of the support bracket 30 and a second end formed with at least one positioning hole 42 selectively mounted on either one of the respective first positioning hole 13 of the first mounting bracket 10, the second positioning hole 22 and the third positioning hole 23 of the second mounting bracket 20.

The first positioning hole 13 of the first mounting bracket 10 is located between the first pivot base 11 and the pivot hole 12. Each of the two sides of the first mounting bracket 10 is bent with an angle which is preferably equal to 10 degrees. The first mounting bracket 10 has a crossbar provided with two spaced rotatable rubber pads 14 each having a side formed with a flattened face 141.

The third positioning hole 23 of the second mounting bracket 20 is located between the second pivot base 21 and the second positioning hole 22. Each of the two sides of the second mounting bracket 20 is bent with an angle which is preferably equal to 20 degrees. The second mounting bracket 20 has a crossbar provided with two spaced rotatable rubber pads 24 each having a side formed with a flattened face 241.

The second pivot base 21 of the second mounting bracket 20 has a central portion formed with a stepped through hole 211 and has a side formed with a plurality of positioning recesses 212 arranged around the through hole 211.

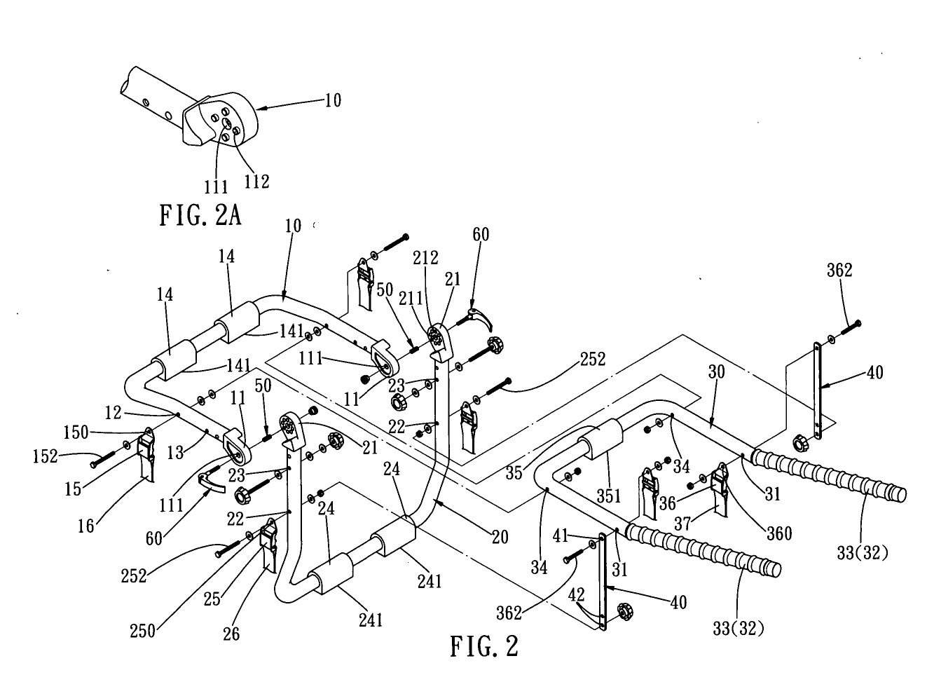

The first pivot base 11 of the first mounting bracket 10 has a central portion formed with a stepped through hole 111 and has a side formed with a plurality of positioning stubs 112 (see FIG. 2A) arranged around the through hole 111 and each detachably locked in a respective one of the positioning recesses 212 of the second pivot base 21 of the second mounting bracket 20.

A quick release 60 is extended through the through hole 111 of the first pivot base 11 of the first mounting bracket 10 and the through hole 211 of the second pivot base 21 of the second mounting bracket 20, and an elastic member 50 is mounted on the quick release 60 and is biased between the through hole 111 of the first pivot base 11 of the first mounting bracket 10 and the through hole 211 of the second pivot base 21 of the second mounting bracket 20.

Thus, when the quick release 60 is tightened, the first pivot base 11 of the first mounting bracket 10 and the second pivot base 21 of the second mounting bracket 20 are pressed to move toward each other, so that each of the positioning stubs 112 of the first pivot base 11 of the first mounting bracket 10 is locked in a respective one of the positioning recesses 212 of the second pivot base 21 of the second mounting bracket 20, thereby combining the first pivot base 11 of the first mounting bracket 10 and the second pivot base 21 of the second mounting bracket 20.

Alternatively, when the quick release 60 is released, the first pivot base 11 of the first mounting bracket 10 and the second pivot base 21 of the second mounting bracket 20 are pushed by the restoring force of the elastic member 50 to separate each other, so that each of the positioning stubs 112 of the first pivot base 11 of the first mounting bracket 10 is detached from a respective one of the positioning recesses 212 of the second pivot base 21 of the second mounting bracket 20, thereby detaching the first pivot base 11 of the first mounting bracket 10 from the second pivot base 21 of the second mounting bracket 20.

Each of the two sides of the support bracket 30 has a second end formed with an oblique support portion 32 having an outside provided with a serrated rubber jacket 33. Each of the two sides of the support bracket 30 is bent with an angle which is preferably equal to 15 degrees. The support bracket 30 has a crossbar provided with a rotatable rubber pads 35 having a side formed with a flattened face 351.

The bike carrying rack further comprises two first fastening members 15 each mounted on a respective one of the two sides of the first mounting bracket 10 and each having a first end formed with a locking hole 150 and a second end provided with a fixing strap 16, and a threaded first locking member 152 each extended through the locking hole 150 of a respective one of the first fastening members 15, the respective pivot hole 12 of the first mounting bracket 10 and the respective pivot hole 34 of the support bracket 30, so that the support bracket 30 is pivotally mounted on the first mounting bracket 10 and each of the first fastening members 15 is fixed on the first mounting bracket 10.

The bike carrying rack further comprises two second fastening members 36 each mounted on a respective one of the two sides of the support bracket 30 and each having a first end formed with a locking hole 360 and a second end provided with a fixing strap 37, and a threaded second locking member 362 each extended through the locking hole 41 of a respective one of the positioning links 40, the respective locking hole 31 of the support bracket 30 and the locking hole 360 of a respective one of the second fastening members 36, so that each of the positioning links 40 is pivotally mounted on the support bracket 30 and each of the second fastening members 36 is fixed on the support bracket 30.

The bike carrying rack further comprises two third fastening members 25 each mounted on a respective one of the two sides of the second mounting bracket 20 and each having a first end formed with a locking hole 250 and a second end provided with a fixing strap 26, and a threaded third locking member 252 each extended through the locking hole 250 of a respective one of the third fastening members 25 and the respective second positioning hole 22 of the second mounting bracket 20, so that each of the third fastening members 25 is fixed on the second mounting bracket 20.

In operation, referring to FIGS. 1-5, when the quick release 60 is released, the first pivot base 11 of the first mounting bracket 10 and the second pivot base 21 of the second mounting bracket 20 are pushed by the restoring force of the elastic member 50 to separate each other, so that each of the positioning stubs 112 of the first pivot base 11 of the first mounting bracket 10 is detached from a respective one of the positioning recesses 212 of the second pivot base 21 of the second mounting bracket 20, thereby detaching the first pivot base 11 of the first mounting bracket 10 from the second pivot base 21 of the second mounting bracket 20. Thus, the first pivot base 11 of the first mounting bracket 10 is pivoted relative to the second pivot base 21 of the second mounting bracket 20 to adjust the included angle between the first mounting bracket 10 and the second mounting bracket 20 so as to fit the configuration of an automobile.

When the quick release 60 is tightened after adjustment of the included angle between the first mounting bracket 10 and the second mounting bracket 20, the first pivot base 11 of the first mounting bracket 10 and the second pivot base 21 of the second mounting bracket 20 are pressed to move toward each other, so that each of the positioning stubs 112 of the first pivot base 11 of the first mounting bracket 10 is locked in a respective one of the positioning recesses 212 of the second pivot base 21 of the second mounting bracket 20, thereby combining the first pivot base 11 of the first mounting bracket 10 and the second pivot base 21 of the second mounting bracket 20 so as to fix the first mounting bracket 10 on the second mounting bracket 20.

Then, the positioning hole 42 of each of the two positioning links 40 is mounted on the respective second positioning hole 22 of the second mounting bracket 20 by the third locking member 252, so that the support bracket 30 is fixed between the first mounting bracket 10 and the second mounting bracket 20.

At this time, the first mounting bracket 10 is pivoted relative to the second mounting bracket 20, so that the included angle between the first mounting bracket 10 and the second mounting bracket 20 is equal to 90 degrees and the positioning hole 42 of each of the two positioning links 40 is mounted on the respective second positioning hole 22 of the second mounting bracket 20.

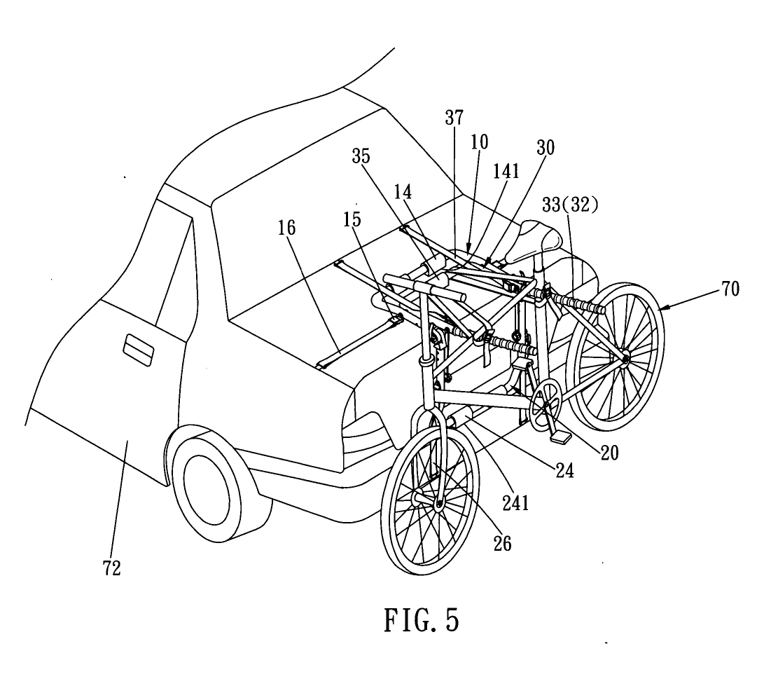

Thus, when the bike carrying rack is mounted on the rear side of the car 72, the flattened face 141 of each of the rubber pads 14 of the first mounting bracket 10 is rested on the trunk of the car 72, the flattened face 241 of each of the rubber pads 24 of the second mounting bracket 20 is rested on the rear bumper of the car 72, and the straps 16, 26 and 37 are hooked on proper positions of the car 72, thereby fastening a bicycle 70 (see FIG. 5) on the support portions 32 of the support bracket 30, so that the bicycle 70 is carried by the car 72.

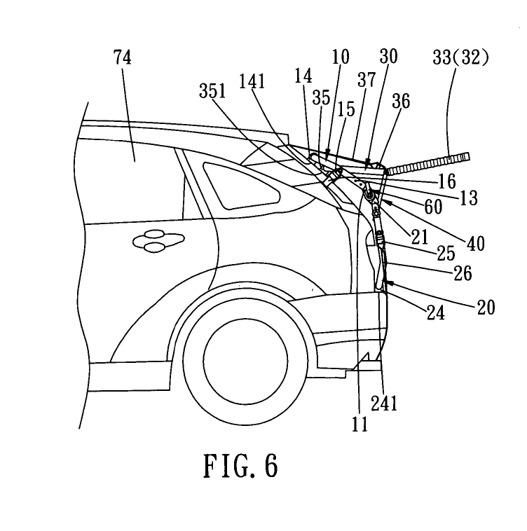

Referring to FIG. 6 with reference to FIGS. 1-3, the first mounting bracket 10 is pivoted relative to the second mounting bracket 20, so that the included angle between the first mounting bracket 10 and the second mounting bracket 20 is equal to 135 degrees. In addition, the positioning hole 42 of each of the two positioning links 40 is mounted on the respective third positioning hole 23 of the second mounting bracket 20.

Thus, when the bike carrying rack is mounted on an oblique rear side of a car 74, the flattened face 141 of each of the rubber pads 14 of the first mounting bracket 10 and the flattened face 351 of the rubber pad 35 of the support bracket 30 are rested on the oblique rear side of the car 74, the flattened face 241 of each of the rubber pads 24 of the second mounting bracket 20 is rested on the rear bumper of the car 74, and the straps 16, 26 and 37 are hooked on proper positions of the car 74, thereby fastening a bicycle on the support portions 32 of the support bracket 30, so that the bicycle is carried by the car 74.

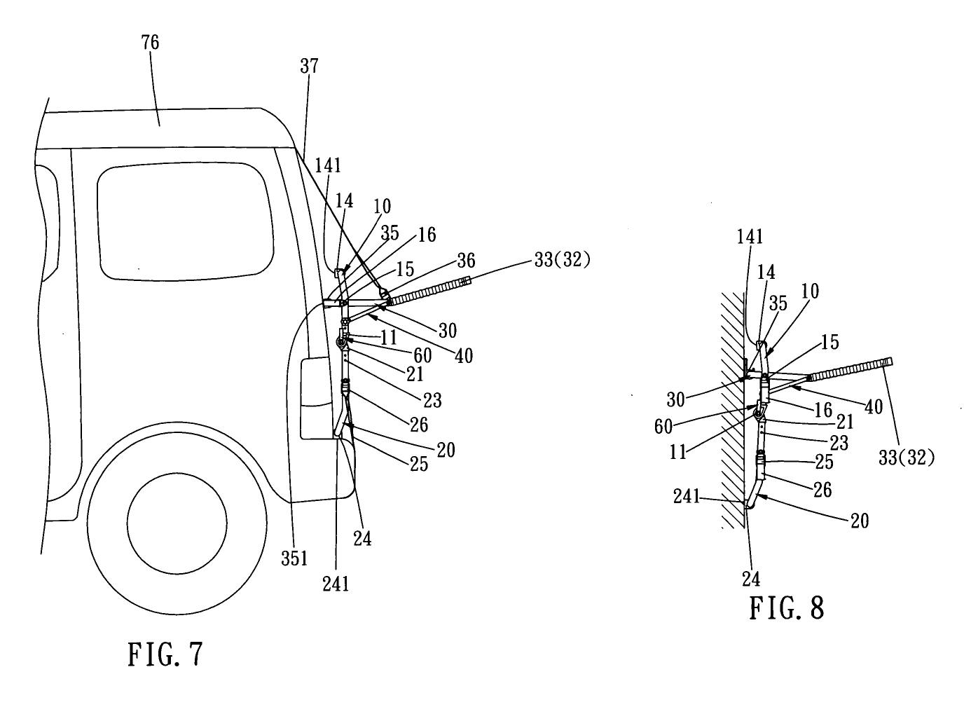

Referring to FIG. 7 with reference to FIGS. 1-3, the first mounting bracket 10 is pivoted relative to the second mounting bracket 20, so that the included angle between the first mounting bracket 10 and the second mounting bracket 20 is equal to 180 degrees. In addition, the positioning hole 42 of each of the two positioning links 40 is mounted on the respective first positioning hole 13 of the first mounting bracket 10.

Thus, when the bike carrying rack is mounted on a vertical rear side of a caravan 76, the flattened face 351 of the rubber pad 35 of the support bracket 30 is rested on the vertical rear side of the caravan 76, the flattened face 241 of each of the rubber pads 24 of the second mounting bracket 20 is rested on the rear bumper of the caravan 76, and the straps 16, 26 and 37 are hooked on proper positions of the caravan 76, thereby fastening a bicycle on the support portions 32 of the support bracket 30, so that the bicycle is carried by the caravan 76.

Referring to FIG. 8, the bike carrying rack is mounted on a vertical wall for supporting a bicycle.

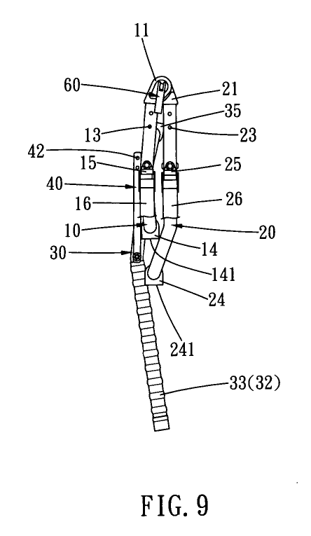

Referring to FIG. 9 with reference to FIGS. 1-3, the positioning hole 42 of each of the two positioning links 40 is detached from the respective first positioning hole 13 of the first mounting bracket 10, the second positioning hole 22 and the third positioning hole 23 of the second mounting bracket 20, and the support bracket 30 is pivoted relative to the first mounting bracket 10, so that the support bracket 30 is parallel with the first mounting bracket 10. In addition, the first mounting bracket 10 is pivoted relative to the second mounting bracket 20, so that the included angle between the first mounting bracket 10 and the second mounting bracket 20 is equal to zero degree, that is, the first mounting bracket 10 and the second mounting bracket 20 overlap each other, thereby folding the bike carrying rack.

Accordingly, the first mounting bracket 10 is pivoted relative to the second mounting bracket 20 to adjust the included angle between the first mounting bracket 10 and the second mounting bracket 20, so that the included angle of the bike carrying rack is adjusted freely to fit cars of different types, thereby enhancing the versatility of the bike carrying rack. In addition, the first pivot base 11 of the first mounting bracket 10 and the second pivot base 21 of the second mounting bracket 20 are combined with and detached from each other by operation of the quick release 60, so that the included angle between the first mounting bracket 10 and the second mounting bracket 20 is adjusted easily and conveniently, thereby facilitating a user adjusting the included angle of the bike carrying rack. Further, the support bracket 30 is fixed between the first mounting bracket 10 and the second mounting bracket 20 by support of the two positioning links 40 so as to enhance the support strength of the bike carrying rack. Further, the bike carrying rack is folded to reduce its volume when not in use, thereby facilitating storage and transportation of the bike carrying rack. Further, the flattened faces 141, 241 and 351 of the rubber pads 14, 24 and 35 are rested on the body of the car to support the bike carrying rack rigidly and stably and to prevent the body of the car from being scratched. Further, the bike carrying rack is mounted on a vertical wall for supporting a bicycle, thereby enhancing the versatility of the bike carrying rack.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A bike carrying rack, comprising:
a substantially U-shaped first mounting bracket having two sides each formed with a first pivot base, a pivot hole and at least one first positioning hole;
a substantially U-shaped second mounting bracket pivotally mounted on the first mounting bracket and having two sides each formed with a second pivot base pivotally mounted on the first pivot base, a second positioning hole and at least one third positioning hole;
a substantially U-shaped support bracket pivotally mounted on the first mounting bracket and having two sides each having a first end formed with a pivot hole pivotally mounted on the respective pivot hole of the first mounting bracket and a mediate portion formed with a locking hole; and
two positioning links each mounted between the first mounting bracket, the second mounting bracket and the support bracket and each having a first end formed with a locking hole mounted on the respective locking hole of the support bracket and a second end formed with at least one positioning hole selectively mounted on either one of the respective first positioning hole of the first mounting bracket, the second positioning hole and the third positioning hole of the second mounting bracket.

2. The bike carrying rack in accordance with claim 1, wherein the first mounting bracket has a crossbar provided with two spaced rotatable rubber pads each having a side formed with a flattened face.

3. The bike carrying rack in accordance with claim 1, wherein the second mounting bracket has a crossbar provided with two spaced rotatable rubber pads each having a side formed with a flattened face.

4. The bike carrying rack in accordance with claim 1, wherein the support bracket has a crossbar provided with a rotatable rubber pads having a side formed with a flattened face.

5. The bike carrying rack in accordance with claim 1, wherein each of the two sides of the support bracket has a second end formed with an oblique support portion having an outside provided with a serrated rubber jacket.

6. The bike carrying rack in accordance with claim 1, wherein the second pivot base of the second mounting bracket has a central portion formed with a stepped through hole and has a side formed with a plurality of positioning recesses arranged around the through hole, the first pivot base of the first mounting bracket has a central portion formed with a stepped through hole and has a side formed with a plurality of positioning stubs arranged around the through hole and each detachably locked in a respective one of the positioning recesses of the second pivot base of the second mounting bracket.

7. The bike carrying rack in accordance with claim 6, further comprising a quick release extended through the through hole of the first pivot base of the first mounting bracket and the through hole of the second pivot base of the second mounting bracket, and an elastic member mounted on the quick release and biased between the through hole of the first pivot base of the first mounting bracket and the through hole of the second pivot base of the second mounting bracket.

8. The bike carrying rack in accordance with claim 1, further comprising two first fastening members each mounted on a respective one of the two sides of the first mounting bracket and each having a first end formed with a locking hole and a second end provided with a fixing strap, and a threaded first locking member each extended through the locking hole of a respective one of the first fastening members, the respective pivot hole of the first mounting bracket and the respective pivot hole of the support bracket, so that the support bracket is pivotally mounted on the first mounting bracket and each of the first fastening members is fixed on the first mounting bracket.

9. The bike carrying rack in accordance with claim 1, further comprising two second fastening members each mounted on a respective one of the two sides of the support bracket and each having a first end formed with a locking hole and a second end provided with a fixing strap, and a threaded second locking member each extended through the locking hole of a respective one of the positioning links, the respective locking hole of the support bracket and the locking hole of a respective one of the second fastening members, so that each of the positioning links is pivotally mounted on the support bracket and each of the second fastening members is fixed on the support bracket.

10. The bike carrying rack in accordance with claim 1, further comprising two third fastening members each mounted on a respective one of the two sides of the second mounting bracket and each having a first end formed with a locking hole and a second end provided with a fixing strap, and a threaded third locking member each extended through the locking hole of a respective one of the third fastening members and the respective second positioning hole of the second mounting bracket, so that each of the third fastening members is fixed on the second mounting bracket.

11. The bike carrying rack in accordance with claim 1, wherein the first positioning hole of the first mounting bracket is located between the first pivot base and the pivot hole.

12. The bike carrying rack in accordance with claim 1, wherein the each of the two sides of the first mounting bracket is bent with an angle equal to 10 degrees.

13. The bike carrying rack in accordance with claim 1, wherein the third positioning hole of the second mounting bracket is located between the second pivot base and the second positioning hole.

14. The bike carrying rack in accordance with claim 1, wherein each of the two sides of the second mounting bracket is bent with an angle equal to 20 degrees.

15. The bike carrying rack in accordance with claim 1, wherein each of the two sides of the support bracket is bent with an angle equal to 15 degrees.
